(19) United States
(12) Patent Application Publication
(10) Pub. No.: US 2005/0086858 A1
(43) Pub. Date: Apr. 28, 2005

(54) Foliage wraps-foliage thermal bags

(76) Inventor: Damon Andrew Schmidt, Largo, FL (US)

Correspondence Address: DAMON ANDREW SCHMIDT, 12685 96th STREET NORTH, LARGO, FL, 33773, US

(21) Appl. No.: 10/673,982

(22) Filed: Sep. 30, 2003

(51) Int. Cl. A01G 13/02

(52) U.S. Cl. 47/20.1

(57) ABSTRACT

This invention relates to a protective device for foliage used to shelter the foliage from frost and/or freezing conditions. More particularly, it relates to foliage protectors, which can, but are not limited to the use of low wattage heating units as an integral part of the protective device. The invention encapsulates the foliage in a flexible enclosure and is available in various sizes and thermal warming capacities. The foliage protector expressly utilizes waste heat from conventional rope light and/or kapton heater tape for providing the heat source.

References Cited [References B [symbol]
U.S. Patent Documents

| | | | |
|---|---|---|---|
| 367134 | Jul., 1887 | Culver | |
| 738588 | Sep., 1903 | Woodwor [symbol] | |
| 935057 | Sep., 1909 | Roberts | |
| 1082439 | Dec., 1913 | Patterson | |
| 1126426 | Jan., 1915 | Hogan | |
| 1600749 | Sep., 1926 | Barnes | |
| 1820040 | Aug., 1931 | Zuckerma [symbol] | |
| 1897382 | Feb., 1933 | Blair | |
| 1987255 | Jan., 1935 | Husted | |
| 2006562 | Jul., 1935 | Scheu | |
| 2835078 | May, 1958 | Whitmore | |
| 2953870 | Sep., 1960 | Nelson | |
| 3466799 | Sep., 1969 | McComb Stilson | |
| 3748783 | Jul., 1973 | Sokolies | |
| 4646467 | Mar., 1987 | Morris roe | 47/20.1 |
| 4829707 | May, 1989 | Koffler et al. | 47/29.2 |
| 4901472 | Feb., 1990 | Donohue et al. | 47/2 |
| 4901472 | Feb., 1990 | Donohue et al. | 47/22 |
| 5575109 | Nov., 1996 | Kuntz | 47/23.3 |
| 6088953 | Jul. 18, 2000 | Morgan | 47/31 |
| 6412217 | Jul. 23, 2002 | Ko | 47/20.1 |
| 6421954 | Jul. 23, 2002 | Ko | 47/20.1 |
| 6588143 | Jul. 8, 2003 | Merrell | 47/20.1 |

Foreign Patent Documents

| | | | |
|---|---|---|---|
| 8002191 | Oct., 1981 | CA | 47/26 |
| 2476435 | Aug., 1981 | FR | 47/26 |
| 631865 | Sep., 1982 | CH | 47/26 |
| 617074 | Feb., 1949 | GB | 47/26 |
| 2456465 | Jan., 1981 | FR | 47/22 |
| 1630667 | Feb., 1991 | SU | 47/22 |

### OBJECTS OF THE INVENTION

Accordingly, objects of the present plant protector are:
to protect tropical and sub-tropical plants from the adverse effects due to frost or freeze;
to provide a hassle free alternative for covering plants other than the ‘traditional’ method of using sheets, clothe pins and bricks;
to provide various size and heat capacity plant covers based on the size and shape of the foliage and the anticipated environmental conditions;
to utilize off-the-shelf kapton tape or rope light as a cost effective and safe means of providing heat inside a fabric enclosure specially designed to cover up delicate plants;
to allow the cascading of the plant covers in a manner very similar to how Christmas lights are interconnected;
to be reusable from year to year;
to be machine washable.

Further objects of the present invention will become apparent from a consideration of the drawings and ensuring embodiment.

### DESCRIPTION OF THE PREFERRED EMBODIMENT

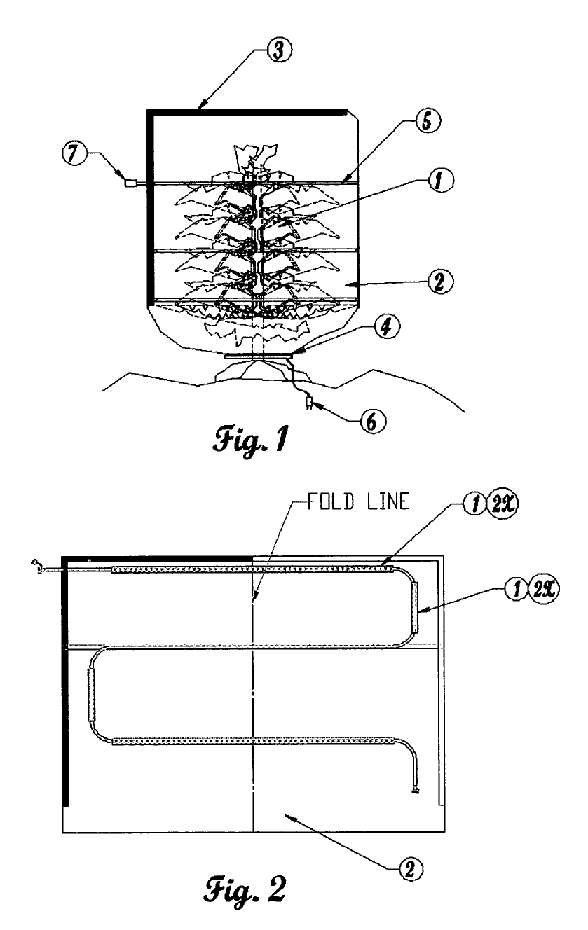

The plant protector (FIG. 1) is constructed from fabric (FIG. 1-2) sewn together in the shape of a flat panel (FIG. 2) that can be used to cover foliage. The plant cover is ‘wrapped’ around the foliage and secured using a restraint mechanism, typically Velcro (FIG. 1-3).

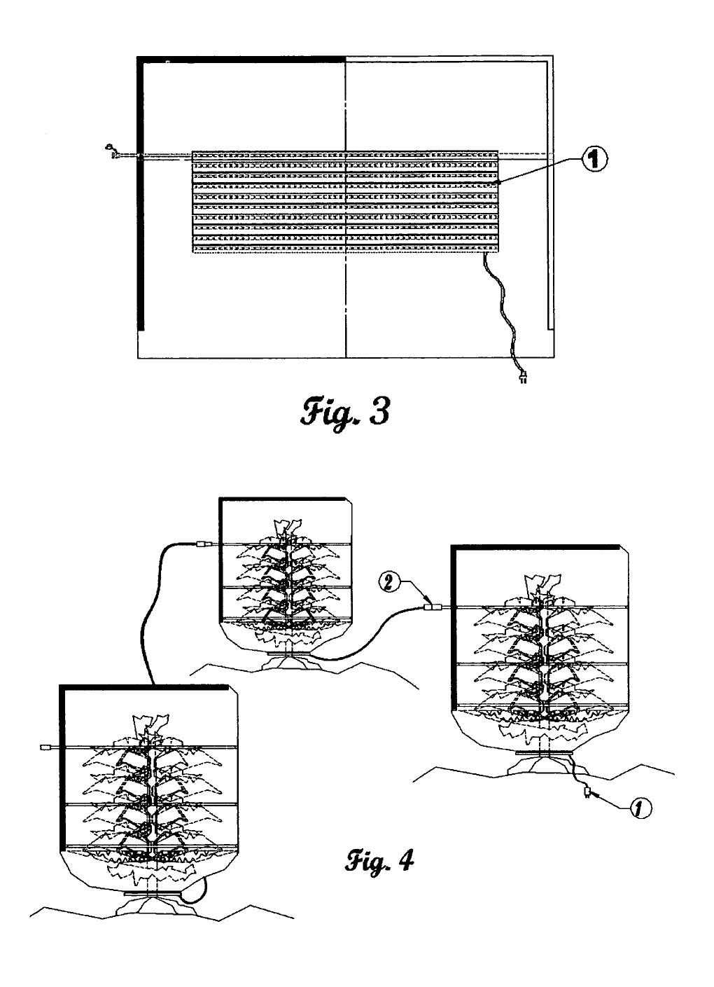

The plant protector has thermal heating (FIG. 1-5) units sewn in the lining, which provides enough heating capacity to keep the interior temperature of the enclosure above temperatures that adversely affect the health of the foliage. The heating units are secured inside pockets (FIG. 2-1) of material sewn into the lining. The pockets space the heating units inside the enclosure for maximum effectiveness. The protective device is available with either rope light or kapton tap (FIG. 3) sewn into the lining. The kapton tap (FIG. 3-1) version is used where maximum heating capacity is required.

The plant protector can be secured around the foliage using a restraint device, typically Velcro (FIG. 1-3), thus forming a protective wrap for the foliage. A drawstring (FIG. 1-4) is attached at the bottom to allow the enclosure to be closed tightly around the base of the plant. Where necessary, clips are available to help secure the wrap to the foliage and help minimize the volume of air contained inside the wrap.

Multiple devices (FIG. 42) can be connected together thus allowing them to be cascaded on one common power line (FIG. 41).

1. A plant protector comprising:
a) a fabric wrap formed into an protective enclosure around the foliage.
i. said protective enclosure can be either used as a flat ground cover or formed, using a restraint device such as Velcro, into a wrap around the foliage and secured at the bottom of the plant using a draw string.
ii. The plant protector is available in various physical sizes
b) a heating unit sewn into the lining of the enclosure

2. The plant protector of claim 1, wherein said heating unit can either be kapton tape or cylindrical rope light.
a) Heating units of various wattages can be installed inside the wrap to allow various thermal capacities for the plant protector.
b) The heating unit is low voltage and powered by 12V and/or 120V prime power with fused protection and all components are pre-approved by UL.

3. The heating unit of claim 2, wherein said heating unit allows the plug in of up to two devices at each plug in point, thus allowing the plant protectors to be cascaded on one common extension cord.
